(19) United States
(12) Patent Application Publication
(10) Pub. No.: US 2004/0236785 A1
(43) Pub. Date: Nov. 25, 2004

(54) Method and system for transmitting a digital image over a communication network

(76) Inventor: Dylan E. Greiner, Oakland, CA (US)

Correspondence Address: Milton S. Sales, Patent Legal Staff, Eastman Kodak Company, 343 State Street, Rochester, NY, 14650-2201, US

(21) Appl. No.: 10/443,388

(22) Filed: May 22, 2003

(51) Int. Cl. G06F 7/00

(52) U.S. Cl. 707/104.1

(57) ABSTRACT

A system, method and software program for transmitting a digital image from a first communication device to a second communication device at a digital image service provider over a communication network. An upload software computer program dynamically analyzes certain properties of the first communication device and of the communication network connection with respect to predetermined criteria, and based on the analysis determines a strategy based on predetermined criteria for transmission of the digital images. For example, the upload software determines the number of communication threads and divides the digital images into a plurality of individual data packets each having a unique ID. The receiving communication device verifies receipt and determines if all of the plurality of individual data packets have been received and requests failed packets be resent.

### FIELD OF THE INVENTION

The present invention is directed to transmitting digital images over a communication network. More particular, for uploading a digital image from a first communication device to a second communication device over a communication network.

### BACKGROUND OF THE INVENTION

With the advent of personal computers and digital cameras there has been a growing need and desire for transmitting digital images over a communication network for sharing and/or obtaining of digital image products. There are a number of Internet photo service provider sites that allow individuals to upload digital images for storage in a customer account and for sharing of images with third parties and/or obtaining digital image products with respect to the digital images that have been uploaded to the service provider. An example of a service provider, is Ofoto Incorporated, which allows users to upload digital images to the site for storage, ordering of image products and/or sharing with other individuals. As it is well known, a single digital image file can be a relatively large digital file which can take a relatively long time to upload to the service provider. The speed and efficiency of this upload will depend upon the equipment of the sender, the configuration of the equipment, and the mode and/or quality of communication. The process time of uploading image files can be even further lengthened when a plurality of image files is uploaded.

Another problem with current upload procedures is that when a failure in uploading image files to the service provider occurs, the sender must go through an entire process of resending the entire image files.

A further problem in transmitting digital image files, is that the reliability of the image file transfer can be effected by a variety of factors. This often result in data not being transferred fully or that the files transferred having a significant number of errors. Again, requiring the retrying of the uploading of the digital images.

A further disadvantage with current uploading systems is that while the uploading of images is taking place, no other action can be taken with respect to images that are in the process of being uploaded. As a result, the user is required to wait until the process is completed before anything else can be done with respect to these images. If the user interrupts the uploading procedure for any reason, the uploading of the image must be started all over.

The present invention is directed to providing an improved method and system for uploading of digital images from a first communication device to a second communication device over a communication network that is directed to solving the problems of the prior art.

### SUMMARY OF THE INVENTION

In accordance with one aspect of the present invention there is provided a method for transmitting a digital image from a first communication device to a second communication device at a digital image service provider over a communication network, comprising the steps of:

providing on the first communication device an upload software computer program for controlling uploading of the digital image from the first communication device, the upload software program dynamically analyzes certain properties of the first communication device and of the communication network connection with respect to predetermined criteria, and based on the analysis configures the first communication device for transmission of the digital image which includes dividing the digital image into a plurality of individual data packets of predetermined sizes for transmission over a determined number of communication threads;

each of the plurality of individual data packets having an unique ID;

transmitting the plurality of individual data packets over the determined number of communication threads to the second communication device;

verifying that each of the individual data packets have been successfully transmitted to the second communication device and resending any individual data packet that were unsuccessfully sent;

determining if all of the plurality of individual data packets have been received with respect to the digital image and transmitting any individual data packets needed to complete the digital image over the determined number of communication threads; and

reassembling the digital image at the second communication device from the plurality of individual data packets.

In accordance with another aspect of the present invention there is provided a system for transmitting a digital image from a first communication device to a second communication device at a digital image service provider over a communication network, comprising the steps of:

a first communication device having an upload software computer program for controlling uploading of the digital image from the first communication device, the upload software program dynamically analyzes certain properties of the first communication device and of the communication network with respect to predetermined criteria, and based on the analysis configures the digital image and the first communication device for transmission of the digital image which includes dividing the digital image into a plurality of individual data packets of predetermined size for transmission over a determined number of communication threads, the upload software computer program breaking the digital image into the plurality of individual data packets, each packet having an unique ID, the first communication device transmitting the plurality of individual data packets over the determined number of communication threads to the second communication device;

a second communication device for communicating with the first communication device over the communication network, the second communication device verifying that each of the individual data packets have been successfully transmitted to the second communication device and sending instruction to the first communication device for resending any individual data packet that was unsuccessfully received by the second communication device, the second communication device determining if all of plurality of individual data packets have been received with respect to digital image and transmitting any individual data packets needed to complete the digital image over the determined number of communication threads on a communication connection established between the first communication device and the second communication device, and reassembling the digital image at the second communication device from the plurality of individual data packets.

In accordance with yet another aspect of the present invention there is provided a computer software program for controlling uploading of a digital image from a client computer to a remote computer at a digital image service provider over a communication network, the software program when loaded on to the computer, will allow the computer to perform the steps of:

dynamically analyzing certain properties of the client computer and of the communication network with respect to predetermined criteria, and based on the analysis configures and the first communication device for transmission of the digital image which includes dividing the digital image into a plurality of individual data packets of predetermined size for transmission over a determined number of communication threads;

each of the plurality of individual data packets having an unique ID; and

transmitting the plurality of individual data packets over the determined number of communication threads to the remote computer.

In accordance with still another aspect of the present invention there is provided a computer software program for controlling uploading of a digital image to a computer, a digital image service provider from a remote client computer over a communication network, the software program when loaded on to the computer will allow the computer to perform the steps of:

receiving a plurality of individual data packets on a communication connection having a plurality of communication threads from the remote client computer over the communication network:

verifying that each of the individual data packets have been successfully received by the computer and requesting resending of any individual data packet that were unsuccessfully sent;

determining if all of the plurality of individual data packets have been received with respect to digital image and requesting the transmission any individual data packets needed to complete the digital image over the plurality of communication threads; and

reassembling the digital image at the computer from the plurality of individual data packets.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

FIG. 1 is a diagrammatic representation of a system made in accordance with the present invention; and

FIG. 2 is a flow chart on how digital images are transmitted from a first communication device to a second communication device over a communication network in accordance with the present invention.

### DETAILED DESCRIPTION OF THE INVENTION

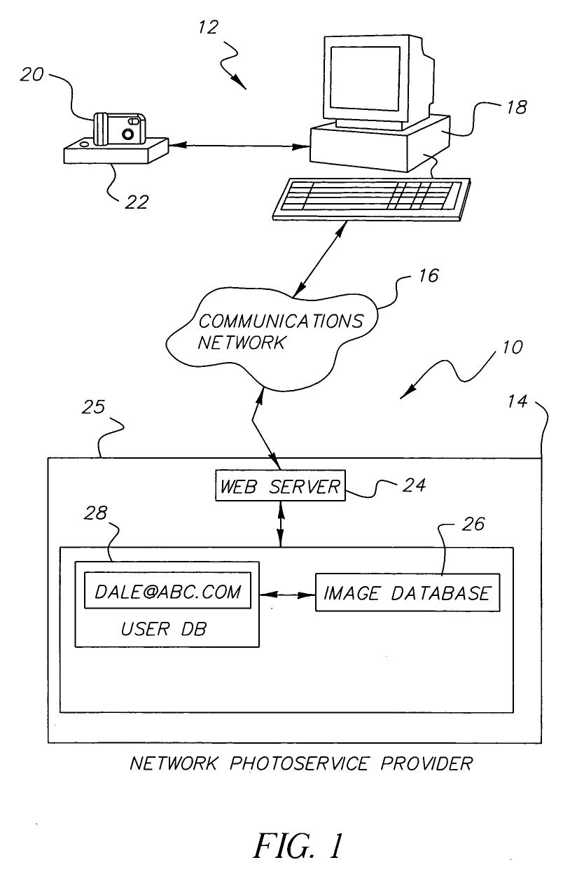

Referring to FIG. 1, there is illustrated a system 10 for allowing transmission of digital images from a first communication device 12 to a second communication device 14 over a communication network 16. In the particular embodiment illustrated, the first communication device 12 comprises a personal computer 18 of a first user. The digital images may be provided on the personal computer 18 by any technique. In the particular embodiment illustrated, digital images may be loaded onto the personal computer 18 from a digital camera 20 that utilizes a communication dock 22 that allows for transferring of digital images from the camera to the PC. It is to be understood that the digital images provided to the personal computer 18 may come from any source using any appropriate technique. For example, but not limited to, scanning of images, CD or other computer disc having images, the receipt of images from another computer or other device such as a PDA capable of transferring images to the computer 18. It is also to be understood that the first communication device 12 is not limited to a personal computer but may comprise of any other device on which images have been stored and/or captured, capable of transmitting images. For example, but not limited to, a digital cellular mobile phone camera device capable of transmitting images over a communication network.

In the particular embodiment illustrated, the communication network 16, comprises the Internet, however, the communication network 16 may be of any particular protocol so long as the digital images are capable of being transferred from a first communication device 12 to a second communication device 14.

In the particular embodiment illustrated, digital images are uploaded from computer 18 to a server 24 of a network photoservice provider 25. As is well known the server 24 may comprise of any appropriate computer that is capable of providing communication with other devices over a communication network 16. In the particular embodiment illustrated, the server 24 is in direct communication with a image database 26 and client server 28 which controls the individuals accessing the network photoservice provider through the web server 24. It is of course understood that the image provider 25 may have other devices and/or computers for managing of the service and providing goods to the parties accessing the site of the photo service provider. It is to be further understood that the second communication device 14 may comprise any other device capable of communicating with the first communication device 12 and for receiving digital images being transmitted over the communication network 16.

Appropriate communication software is provided on the web server 24 that is designed to communicate with an upload software program running on computer 18. The upload software program on the computer 18 and software program on web server 24 are designed to communicate and exchange information with respect to the digital images to be uploaded. In addition, the software programs are designed, as is later described, to manage the manner in which the digital image files are to be transferred.

The upload software program on the first communication device 12 is designed for communication with the communication device 14 in a manner so that information can be efficiently transferred in a highly reliable manner, allows flexibility with regard to doing other tasks while images are being forwarded, and minimizes the time for transmitting data between the two communication devices.

The software programs on the computer 18 and server 24 are designed to transmit and receive individual packets of digital data along a plurality of communication threads that are established over a communication link between the first communication device 12 the second communication device 14. Further, the software programs are designed such that specific predetermined criteria is used for determining an upload strategy for the most efficient manner of transmitting data over the current communication link (connection). Various factors will affect the upload strategy, for example but not by way of limitation, certain policies selected by the user and/or policies required by the receiving communication devices or other operating parameters that may affect the upload run time.

In particular, the upload software on communication device 12 analyzes the particular communication device 12 that is used for transmitting of the image. For example, the upload software program determines the particular type of device, for example a computer, the particular type of processor, the speed of the processor, the device configuration, and any other appropriate characteristics of the first communication device 12 that may affect transmission of digital data to be transmitted. In addition, the upload software on communication device 12 analyzes the particular mode of communication that currently exists and the type of service that is to be provided in the transferring of the digital image to the second communication device 14. For example, if the communication link is a broad-band (high speed) communication connection or slower narrow band communication connection (for example a dial-up connection). Based on this analysis and predetermined criteria set forth in the upload software program, the upload software program determines a strategy on how the digital image files are to transmitted. For example, the software on the first communication device 12 determines the number and size of digital data packets, the digital image files are to be divided into and the appropriate number of communication threads that are to be established over the communication link established between the computer 18 and server 24. Applicants have found that at least two communication threads are required preferably between 3-6 communication threads are utilized. While any number of communication threads may be provided, it has been found that when a certain number of communication threads exceeded, there no longer an advantage with respect to improved transmission run times.

It is believed that the minimum number of digital data packets should be at least two (2). Preferably the number of digital packets is no more that 1,000 for any particular digital image file. Additionally, it is believed that the packet size should be no less than about (4) kilobytes and no greater than about one (1) megabyte, preferably the data packets each have a size in the range 64 to 512 kilobytes.

Various other predetermined criteria which will affect the determination as to the manner in which the image files sent may also be taken into consideration. For example but not limited to, the minimum and maximum amount of image resolution that can be sent. It has been found desirable that images have a minimum resolution in the x direction and the y direction. Preferably of about 340 in the long direction and about 240 in the short direction, and preferably with a maximum resolution of 7500 in the short direction 10,000 pixel resolutions long direction. Additionally, a predetermined criteria for each image file size is preferably that the image has a maximum file size no greater than about 20 megabytes.

If certain predetermined criteria (guidelines/policies) are exceeded, various type messages may be generated by the software on the computer 18 or at the server 24 and forwarded to computer 18. One type of message that could be created is setting forth a warning that the image to be sent will either not be sufficient for an appropriate print or is greater than the size that which typically would be stored at the service provider site. A second type message could be an informational message that an additional charge would be made for the excessive size of the image. Still another type of message could be generated advising that an error has occurred in the image and has been rejected from being uploaded. For example, that the image file has exceeded the maximum resolution or maximum file size. Warnings typically advise the user that a potential problem may arise with respect to the image file. For example, that the image file resolution is smaller than the minimum required for providing a particular type or size print, or the image file may contain a custom color profile. Other messages simply server to inform the user of some aspect of an image file. For example, the degree of quality of the printing that may result from the use of such image.

Various other predetermined criteria can also be determined upon activation of upload software program or when there is communication between the upload software on first communication device 12 with the software on the second communication device 14. The upload software could determine if the user is a member of a particular class of users. If the user of the communication device 12 pays a particular premium for a particular service, this information could be utilized by the upload. For example, but not by way of limitation, if the user is a premium user that pays extra, larger uploads or downloads may be enabled as opposed to other users who are non-premium users.

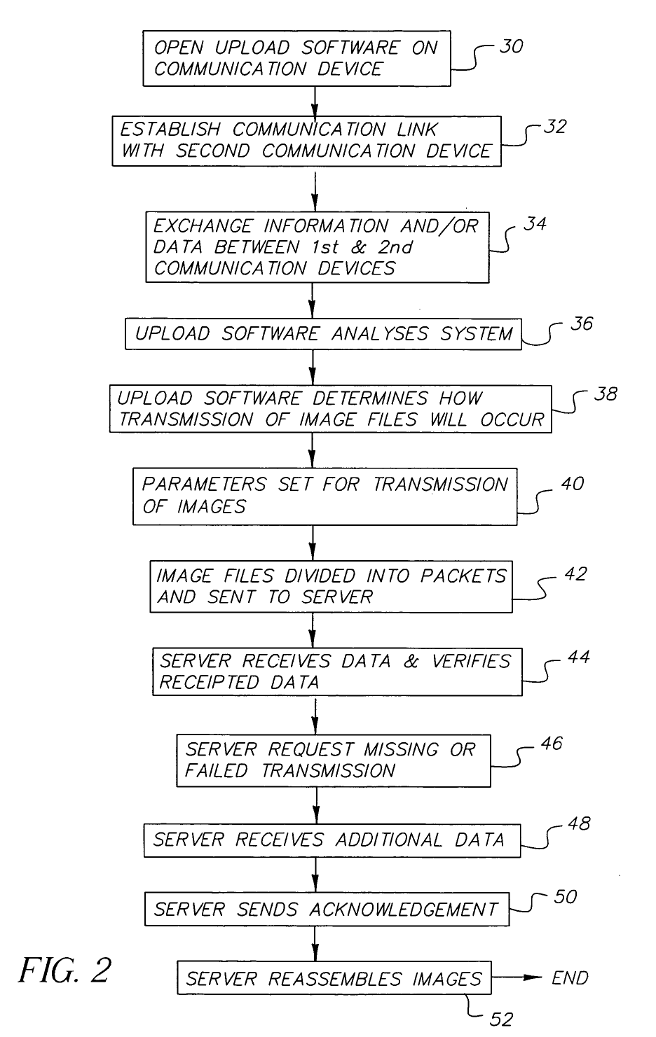

In order to better understand the operation of the present invention, a description of one example on how data may be transferred from first communication device 12 to the second communication device 14 will be provided with reference to FIG. 2 which is a flow chart of the operation for transferring digital images files according to the present invention.

The first step 30 would be to open the upload software program on the communication device 12. This would then initiate a communication connection with the web server 24 at step 32. In the embodiment illustrated, this would be an Internet communication connection. This communication connection may be broad band (high speed connection) or a slower narrower band communication connection. After initiation of the communication connection, appropriate information and/or data is passed between the web server 24 to the upload software on communication device 18 at step 34. For example, information may be provided for updating of the capabilities of the software in first communication device 12, including but not limited to software program updates to be incorporated in the upload software on communication device 12. The upload software program at step 36 analyzes digital image files and system configuration in accordance with the various predetermined criteria and at step 38 determines how transmission of the digital image files will occur. Once this has been completed, the upload software program at step 40 sets the various parameters that will be used in transmitting of the digital image files.

At step 42 the selected images divided into appropriate digital data packets and transmitted to server 24 over the determined number of communication threads to be used for transmitting of the packets to the server 24. For the purposes of this application a communication thread is a single communication channel over which information, processing, and/or instructions can be transmitted. Prior to forwarding of digital data to the server 24, instructional metadata is created and placed in front of the digital data to be transmitted. In the embodiment illustrated the instructional metadata is embedded in a stream of XML. The instructional metadata includes a variety of information for use by the communication software on server 24 in determining what information is to be received, for use in verifying receipt of such items, reassembling the data or other purpose (for example, diagnostic use). Some of the information in the instructional metadata would include a check sum for use in verifying receipt of data to transmitted, a transaction ID is provided for identifying the transaction that is occurring, information regarding the number of packets that are to be transmitted; the ID for each packet, the length of each of the packets, offset information providing information with respect to where the packet data begins and indicating the address of each of the packets, and total size of the file being sent. Due to the manner of transmission of the data packets, the data packets need not be in any particular order due to their particular identification. The information provided by the instructional metadata at step 44 is used by the server 24 for a variety of purposes, for example, to confirm receipt of information, that a particular data packet was not completely received. In a situation where items have not been properly sent or there was a failure in sending, an appropriate request at step 46 will be sent to the software at computer 18 for resending of any missing data. The upload software at step 48 sends any missing data or resends any data that failed to be received properly. Once everything has been received, an acknowledgement block at step 50 is sent from the server 24 back to the upload software at computer 18 verifying what has been received. Finally at step 52 the server 24 reassembles the data to recreate the digital images files sent. These images are stored or otherwise handled as requested by the user that uploaded the digital images. For example, but not by way of limitation, the digital images may be stored in a customer account, used to obtain digital image products such as prints, album, etc., or resent by the service provider to a third party.

Since each packet has a unique ID, it is easy to identify packets that were not transmitted or failed during transmission. Additionally, because the digital data packets each have been provided with individual IDs and appropriate information has been provided to the server as to how to assemble the information, the packets can be sent in any particular order. Thus, it does not matter which one of the communication threads are used for forwarding of the packets and data to the server. During the uploading of the digital image files, due to the packetization and the multiple communication threads it is possible to continue communication between the software on the computer 18 and the software on server 24. This allows the user to perform other tasks with the upload software program while uploading is occurring. For example, but not by way of limitation, if during the uploading of an image, the user determines that they did not wish to send a particular image, a message is issued instructing the server to remove the image file or otherwise suspend transfer of the image. Also if the user needed to quit the uploading for any reason, the user can pause the uploading and the user at a later time, even during a different communication connection, can continue with the uploading of the image from the first communication device 12 to the second communication device without losing any data or starting from the beginning. Next, at step 42, the software breaks up the image data into data packets and forwards it to the server 24. At step 44, verification of each individual packet is conducted as each packet is received. Any unsuccessfully transmitted packets are noted and a request from the server is sent back down to the software at computer 18 for resending of any packets that may have been unsuccessfully sent. Additionally, the software at server 24, determines at step 46 if there are any missing packets in which case, if there are the missing packets, such packets are transmitted to the server 24. At step 48, the packets are reassembled in the appropriate order and an appropriate confirmation is sent down to the software on computer 18 acknowledging what has been received.

It is to be understood that any predetermined criteria may be taken into consideration when determining how the communication link is to be established and how the image data is to be transmitted between the first communication device and second communication device. This may be done before or during transmission of the data packets. For example, if the sever is taken out of service and a second server is to take its place, the timing information can be conveyed to the first communication device.

It is to be understood that various modifications and changes may be made without departing from the present invention, the present invention being defined by the following claims.

### Parts List

10 system

12 first communication device

14 second communication device

16 communication network

18 personal computer

20 digital camera

22 communication dock

24 server

25 network service provider

26 image database

28 client server

30 step

32 step

34 step

36 step

38 step

40 step

42 step

44 step

46 step

48 step

50 step

52 step

What is claimed is:

1. A method for transmitting a digital image from a first communication device to a second communication device at a digital image service provider over a communication network, comprising the steps of:
providing on said first communication device an upload software computer program for controlling uploading of said digital image from said first communication device, said upload software program dynamically analyzes certain properties of said first communication device and of said communication network link with respect to predetermined criteria, and based on said analysis configures said first communication device for transmission of said digital image which includes dividing said digital image into a plurality of individual data packets of predetermined sizes for transmission over a determined number of communication threads each of said plurality of individual data packets having a unique ID;
transmitting said plurality of individual data packets over said determined number of communication threads to said second communication device;
verifying that each of said individual data packets have been successfully transmitted to said second communication device and resending any individual data packet that were unsuccessfully sent;
determining if all of said plurality of individual data packets have been received with respect to said digital image and transmitting any individual data packets needed to complete said digital image over said determined number of communication threads; and
reassembling said digital image at said second communication device from said plurality of individual data packets.

2. The method according to claim 1 wherein said predetermined criteria comprises dynamic run-time policy data.

3. The method according to claim 1 wherein said predetermined criteria comprises upload packetization & parallelization parameters.

4. The method according to claim 1 wherein said predetermined criteria comprises what is required by the first communication device.

5. The method according to claim 1 wherein said predetermined criteria are determined by said second communication device.

6. The method according to claim 1 wherein said predetermined criteria comprises upload strategy.

7. The method according to claim 1 wherein said predetermined criteria comprises user specific policies.

8. The method according to claim 1 wherein said predetermined criteria comprises at least one run-time parameters.

9. The method according to claim 1 wherein said upload software computer program is automatically updated when it is connected to said second communication device.

10. The method according to claim 1 wherein said transmission is paused before all of said individual data packets have been transmitted and transmission of said digital image is resumed from where it was paused.

11. The method according to claim 10 wherein said pause was initiated by said first communication device.

12. The method according to claim 10 wherein said pause was initiated by said second communication device.

13. The method according to claim 1 wherein said verification of transmission of said individual data packets is accomplished by a check sum technique.

14. The method according to claim 1 wherein said configuration of transmission also take into account the properties of the second communication device.

15. The method according to claim 14 wherein said properties of said second communication device comprises the current operating parameters of said second communication device.

16. The method according to claim 1 wherein said transmission of said individual data packets permits operation of said first communication device with respect to other computer operations.

17. The method according to claim 1 wherein said second communication device is a server.

18. The method according to claim 1 wherein the size of each of said image packets is no greater than about one (1) megabytes.

19. The method according to claim 1 wherein the size of each of said image packets is in the range of 64 to 512 kilobytes.

20. The method according to claim 1 wherein the size of each of said image packets is no less than about 4 kilobytes.

21. The method according to claim 1 wherein the number of communication threads comprises at least two.

22. The method according to claim 21 wherein the number of communication threads is in the range of 3 to 6.

23. The method according to claim 1 wherein said first communication device comprises a computer.

24. The method according to claim 1 wherein said first communication device comprises a phone.

25. The method according to claim 1 wherein said first communication device comprises a PDA.

26. The method according to claim 1 wherein said second communication device comprises a computer.

27. The method according to claim 1 wherein said second communication device comprises a phone.

28. The method according to claim 1 wherein said second communication device comprises a PDA.

29. A system for transmitting a digital image from a first communication device to a second communication device at a digital image service provider over a communication network, comprising the steps of:
a first communication device having an upload software computer program for controlling uploading of said digital image from said first communication device, said upload software program dynamically analyses certain properties of said first communication device and of said communication network with respect to predetermined criteria, and based on said analyzes configures said digital image and said first communication device for transmission of said digital image which includes dividing said digital image into a plurality of individual data packets of predetermined size for transmission over a determined number of communication threads, said upload software computer program breaking said digital image into said plurality of individual data packets, each packet having an unique ID, said first communication device transmitting said plurality of individual data packets over said determined number of communication threads to said second communication device;
a second communication device for communicating with said first communication device over said communication network, said second communication device verifying that each of said individual data packets have been successfully transmitted to said second communication device and sending instruction to said first communication device for resending any individual data packet that unsuccessfully received by said second communication device, said second communication device determining if all of plurality of individual data packets have been received with respect to a digital image and transmitting any individual data packets needed to complete said digital image over said determined number of communication threads on a communication connection established between said first communication device and said second communication device, and reassembling said digital image at said second communication device from said plurality of individual data packets.

30. A computer software program for controlling uploading of a digital image from a client computer to a remote computer at a digital image service provider over a communication network, said software program when loaded onto said computer will allow the computer to perform the steps of:
dynamically analyzing certain properties of said client computer and of said communication network with respect to predetermined criteria, and based on said analysis configures and said first communication device for transmission of said digital image which includes dividing said digital image into a plurality of individual data packets of predetermined size for transmission over a determined number of communication threads, each of said plurality of individual data packets having a unique ID; and
transmitting said plurality of individual data packets over said determined number of communication threads to said remote computer.

31. A computer program according to claim 30 further comprising the steps of:
resending any individual data packet that was unsuccessfully sent to said remote computer; and
transmitting any individual data packets needed to complete said digital image over said determined number of communication.

32. A computer software program for controlling uploading of a digital image to a computer, a digital image service provider from a remote client computer over a communication network, said software program when loaded on to said computer will allow the computer to perform the steps of:
receiving a plurality of individual data packets on a communication connection having a plurality of communication threads from said remote client computer over said communication network:
verifying that each of said individual data packets have been successfully received by said computer and requesting resending of any individual data packet that were unsuccessfully sent;
determining if all of the plurality of individual data packets have been received with respect to digital image and requesting the transmission of any individual data packets needed to complete said digital image over said plurality of communication threads; and
reassembling said digital image at said computer from said plurality of individual data packets.
